(19) United States
(12) Patent Application Publication
(10) Pub. No.: US 2026/0003059 A1
(43) Pub. Date: Jan. 1, 2026

(54) HIGH-RESOLUTION DOPPLER ESTIMATION

(71) Applicant: Intel Corporation, Santa Clara, CA (US)

(72) Inventors: Yi LIANG, Shanghai (CN); Xiaowen ZHANG, Shanghai (CN)

(21) Appl. No.: 19/334,034

(22) Filed: Sep. 19, 2025

(30) Foreign Application Priority Data
Aug. 17, 2025 (WO) PCTCN2025115250

(51) Int. Cl. G01S 13/58; G01S 7/00

(52) U.S. Cl. CPC G01S 13/58; G01S 7/006

(57) ABSTRACT

The disclosure described herein generally relates to a system including one or more processors and one or more non-transitory computer-readable media storing instructions that, when executed by the one or more processors, cause the one or more processors to receive a first signal for spectral analysis wherein the first signal is a time division duplex (TDD) signal, apply a MUltiple SIgnal Classification-like (MUSIC-like) algorithm to the first signal to obtain one or more Doppler regions of interest, perform a high-resolution Doppler estimation utilizing Least Absolute Shrinkage and Selection Operator (LASSO) algorithm within the one or more Doppler regions of interest, and output a high-resolution Doppler spectrum for the first signal.

### RELATED APPLICATION

This application claims the benefit of priority to Patent Cooperation Treaty (PCT) Application No. PCT/CN2025/115250, filed Aug. 17, 2025. The entire content of that application is incorporated by reference in its entirety.

### BACKGROUND

In 5G New Radio (NR) time division duplex (TDD) systems, integrated sensing and communications (ISAC) applications require accurate and high-resolution velocity (Doppler) estimation. Traditional Doppler estimation techniques depend on uniformly sampled reference signals. However, due to the nature of TDD, achieving strictly uniform sampling for the reference signals necessitates a much longer effective sampling interval, which severely limits the maximum detectable velocity. Conversely, employing non-uniform sampling introduces ambiguity and mirroring artifacts in the Doppler spectrum. These limitations hinder the deployment of ISAC in practical 5G NR TDD systems, especially for applications such as vehicular sensing, radar, and high-mobility user tracking.

### BRIEF DESCRIPTION OF THE DRAWINGS

FIG. 1 illustrates an example signal processing system.

FIG. 2 illustrates an example of a logic flow.

FIG. 3 illustrates another example of a logic flow.

FIG. 4 illustrates yet another example of a logic flow.

FIG. 5 is a schematic diagram illustrating Measurement Deviation of Velocity versus Signal-to-Noise Ratio (SNR) for different algorithms.

FIG. 6 is a schematic diagram illustrating a magnified view of Measurement Deviation of Velocity versus SNR for different algorithms.

### DETAILED DESCRIPTION

In the following description, numerous specific details are set forth in order to provide a thorough understanding of the present disclosure. However, it will be apparent to those skilled in the art that the implementations of the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring the disclosure.

The accompanying drawings, which are incorporated herein and form a part of the specification, illustrate the present disclosure and, together with the description, further serve to explain the principles and to enable a person skilled in the pertinent art to make and use the techniques discussed herein. In the drawings, like reference characters generally refer to the same parts throughout the different views. The drawings are not necessarily to scale, emphasis instead generally being placed upon illustrating the principles of the disclosure.

The present disclosure will be described with reference to the accompanying drawings. The drawing in which an element first appears is typically indicated by the leftmost digit(s) in the corresponding reference number.

The word “exemplary” is used herein to mean “serving as an example, instance, or illustration.” The words “plurality” and “multiple” in the description and claims refer to a quantity greater than one. The terms “group”, “set”, “sequence,” and the like refer to a quantity equal to or greater than one. Any term expressed in plural form that does not expressly state “plurality” or “multiple” similarly refers to a quantity equal to or greater than one. The term “reduced subset” refers to a subset of a set that contains less than all elements of the set. Any vector and/or matrix notation utilized herein is exemplary in nature and is employed for purposes of explanation. Examples of this disclosure described with vector and/or matrix notation are not limited to being implemented with vectors and/or matrices and the associated processes and computations may be performed in an equivalent manner with sets or sequences of data or other information.

As used herein, “memory” is understood as a non-transitory computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” refers to any type of executable instruction, including firmware.

While some examples in this disclosure may refer to specific radio communication technologies, the examples provided herein may be similarly applied to various other radio communication technologies, both existing and not yet formulated, particularly in cases where such radio communication technologies share similar features as disclosed regarding the following examples. For purposes of this disclosure, radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (WITS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (12V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHZ), ITS-G5B (i.e., Operation in European ITS frequency bands dedicated to ITS non-safety applications in the frequency range 5,855 GHz to 5,875 GHZ), ITS-G5C (i.e., Operation of ITS applications in the frequency range 5,470 GHz to 5,725 GHZ)), DSRC in Japan in the 700 MHz band (including 715 MHz to 725 MHz), IEEE 802.11bd based systems, etc.

Examples described herein can be used in the context of any spectrum analysis scheme including dedicated licensed spectrum, unlicensed spectrum, license exempt spectrum, (licensed) shared spectrum (such as LSA=Licensed Shared Access in 2.3-2.4 GHz, 3.4-3.6 GHZ, 3.6-3.8 GHz and further frequencies and SAS=Spectrum Access System/CBRS=Citizen Broadband Radio System in 3.55-3.7 GHZ and further frequencies). Applicable spectrum bands include International Mobile Telecommunications (IMT) spectrum as well as other types of spectrum/bands, such as bands with national allocation (including 450-470 MHZ, 902-928 MHz (note: allocated for example in US (FCC Part 15)), 863-868.6 MHZ (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHZ (note: allocated for example in China), 790-960 MHz, 1710-2025 MHZ, 2110-2200 MHz, 2300-2400 MHZ, 2.4-2.4835 GHz (note: it is an ISM band with global availability and it is used by Wi-Fi technology family (11b/g/n/ax) and also by Bluetooth), 2500-2690 MHZ, 698-790 MHZ, 610-790 MHZ, 3400-3600 MHZ, 3400-3800 MHz, 3800-4200 MHz, 3.55-3.7 GHZ (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHZ (note: allocated for example in EU (ETSI EN 301 893)), 5.47-5.65 GHZ (note: allocated for example in South Korea, 5925-7125 MHz and 5925-6425 MHz band (note: under consideration in US and EU, respectively. Next generation Wi-Fi system is expected to include the 6 GHZ spectrum as operating band but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHZ, 3800-4200 MHZ, 3.5 GHz bands, 700 MHz bands, bands within the 24.25-86 GHz range, etc.), spectrum made available under FCC's “Spectrum Frontier” 5G initiative (including 27.5-28.35 GHZ, 29.1-29.25 GHZ, 31-31.3 GHZ, 37-38.6 GHZ, 38.6-40 GHZ, 42-42.5 GHz, 57-64 GHZ, 71-76 GHZ, 81-86 GHz and 92-94 GHZ, etc.), the ITS (Intelligent Transport Systems) band of 5.9 GHZ (typically 5.85-5.925 GHZ) and 63-64 GHZ, bands currently allocated to WiGig such as WiGig Band 1 (57.24-59.40 GHZ), WiGig Band 2 (59.40-61.56 GHZ) and WiGig Band 3 (61.56-63.72 GHZ) and WiGig Band 4 (63.72-65.88 GHZ), 57-64/66 GHz (note: this band has near-global designation for Multi-Gigabit Wireless Systems (MGWS)/WiGig. US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHZ, bands currently allocated to automotive radar applications such as 76-81 GHZ, and future bands including 94-300 GHz and above. Furthermore, the scheme can be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

5G New Radio (NR) may represent a significant advancement in wireless communication systems. It may offer high data rates, ultra-low latency, and massive device connectivity. These capabilities may support diverse applications beyond traditional mobile broadband. In 5G NR systems, time division duplex (TDD) operation may offer spectral efficiency benefits. TDD utilizes the same frequency band for both uplink and downlink transmissions. This may enhance spectral efficiency through flexible time allocation. Integrated sensing and communications (ISAC) may leverage this TDD framework. ISAC emerges as a transformative application within 5G NR TDD frameworks. Typical applications may include vehicular sensing, radar, and high-mobility user tracking. For example, vehicular sensing may enable collision avoidance systems. Radar-like functionality may support short-range object detection and localization. High-mobility user tracking may maintain connectivity for passengers on high-speed trains traveling at a speed of over 300 km/h.

ISAC may utilize existing infrastructure for simultaneous data transmission and environmental sensing. Signals transmitted for communication may reflect from objects in the environment. These reflected signals may return to the receiver. The reflected signals may carry critical information about encountered objects. Crucially, this information may include changes in the signal's properties, such as its frequency. These frequency changes may be influenced by the relative motion between the target objects and the transceivers. Specifically, target motion may cause measurable frequency shifts in the reflected signals. This phenomenon is known as the Doppler shift.

These applications critically depend on accurate velocity estimation. Achieving the necessary performance may present significant challenges. Effective Doppler estimation techniques may critically support ISAC sensing performance. Consequently, limitations in Doppler estimation may directly constrain practical ISAC deployment. Achieving high-resolution velocity estimation may face fundamental constraints in TDD systems due to frame structure limitations.

Consider a typical 3GPP NR TDD slot pattern 7D1S2U (DDDDDDDSUU). In this configuration, seven downlink slots, one special slot and two uplink slots per frame may be allocated. 7 downlink slots may be allocated per 10-slot frame for sensing. Downlink reference signals may transmit only during the seven downlink slots. In a case employing uniform sampling, for example, the minimum sampling interval may be denoted as T_{uniform}. For strictly uniformly sampling, the velocity range that can be estimated is

$$[ - \frac{1}{2 \cdot {T}_{uniform}} , \frac{1}{2 \cdot {T}_{uniform}} ] .$$

In cases employing non-uniform sampling, for example, the minimum sampling interval may be denoted as T_{non-uniform}. For non-uniformly

$$[ - \frac{1}{2 \cdot {T}_{non - uniform}} , \frac{1}{2 \cdot {T}_{non - uniform}} ] .$$

sampling, the velocity range that can be estimated is

Achieving uniformly sampling may require transmitting reference signals only in corresponding positions across multiple frames. The uniform sampling may require waiting for corresponding slots across multiple frames. This enforcement of periodicity may extend the minimum sampling interval to 10 slots or more. Non-uniformly sampling within available downlink slots may offer a theoretical advantage. By utilizing all 7 downlink slots per frame without synchronization constraints, the minimum sampling interval may reduce to 1 slot. T_{uniform} may be ten times T_{non-uniform}. Consequently, the velocity range of non-uniformly sampling may be ten times the velocity range of

$$[ - \frac{1}{2 \cdot {T}_{uniform}} , \frac{1}{2 \cdot {T}_{uniform}} ] .$$

uniformly sampling. may be ten times

$$[ - \frac{1}{2 \cdot {T}_{non - uniform}} , \frac{1}{2 \cdot {T}_{non - uniform}} ] .$$

Thus, ten times the detection range may be obtained by non-uniformly sampling. Such expansion may be essential, for example, for tracking hypersonic vehicles or high-speed trains. This makes non-uniformly sampling highly desirable despite its inherent challenges.

Existing technical approaches for non-uniformly sampling may suffer significant limitations. Previous solutions may attempt interpolation onto uniform grids before standard Fourier analysis. These methods may introduce substantial spectral distortion. Other approaches may apply basic periodogram techniques directly to irregular samples. Ignoring non-uniformity may exacerbate mirroring artifacts. This may cause severe spectral leakage. Furthermore, ambiguous mirror artifacts may appear across the Doppler spectrum. Genuine high-speed targets may create false low-velocity ghost images. Velocity resolution may degrade substantially. Reliable discrimination between true targets and artifacts may become problematic. As a result, the theoretically achievable 10 times velocity range may remain practically unrealizable with these methods. These limitations may fundamentally hinder ISAC deployment. Robust, high-resolution Doppler estimation from non-uniformly sampled data in TDD-based ISAC systems remains a significant challenge so far.

Therefore, determining target velocity may fundamentally require precise measurement of this Doppler frequency shift. Effective Doppler estimation techniques may critically support ISAC sensing performance.

FIG. 1 illustrates an example signal processing system. In some examples, as shown in FIG. 1, the signal processing system 100 may be a Doppler region engine. The signal processing system 100 may include a Doppler region identifier 101 and a high-resolution Doppler estimator 102. The signal processing system 100 may be within an ISAC subsystem. The signal processing system 100 may be realized in firmware or hardware. In some examples, the signal processing system 100 may interface with both radio front-end circuits for signal acquisition and higher-layer sensing applications for delivering processed Doppler information.

In some examples, the signal processing system 100 may be coupled with an ISAC Sensing Processor 200, as shown in FIG. 1. The signal processing system 100 and the ISAC Sensing Processor 200 may communicate via standardized Application Programming Interfaces (APIs). The signal processing system 100 may compute velocity/range vectors from raw data. The signal processing system 100 may package results into structured messages. The signal processing system 100 may push these vectors to the ISAC Sensing Processor 200.

In an example process under TDD with non-uniform sampling in a 5G NR TDD system, the signal processing system 100 may receive a reference signal sampled non-uniformly in time due to TDD scheduling. The reference signal may be obtained from a TDD system. The signal may be preprocessed to account for the non-uniform sampling intervals, normalizing the data for subsequent spectral analysis.

The Doppler region identifier 101 may be a processing circuit configured for performing Doppler region identification based on a MUSIC-like algorithm. MUSIC algorithm, short for MUltiple SIgnal Classification (MUSIC) algorithm, is a high resolution direction of arrival (DOA) estimation method. Algorithms preserving the eigen-decomposition core of MUSIC but modifying covariance estimation or subspace projection are categorized as MUSIC-like methods. The MUSIC-like algorithms may be employed to estimate the directions of arrival of signals. The signals may come from sources like radio waves or sounds. The MUSIC-like algorithms may work with data from sensor arrays. The MUSIC-like algorithms may separate the sensor data space, identifying the space into two subspaces including the signal subspace and the noise subspace. True signal directions correspond to vectors orthogonal to the noise subspace.

In the MUSIC-like algorithms performed on the Doppler region identifier 101, the preprocessed signal may be used to determine a covariance matrix, for example, to construct a covariance matrix. Eigen-decomposition may be performed to separate the signal subspace and the noise subspace. The MUSIC-like algorithm may scan the Doppler frequency axis to identify regions with significant signal energy, even under non-uniform sampling.

The MUSIC-like algorithm may generate an initial Doppler spectrum estimate, which inherently contains high-frequency fluctuations due to noise and finite sampling effects. To enhance the reliability of peak detection, a low-pass filter to suppress spectral noise may be applied while preserving dominant Doppler components. Within this smoothed spectrum, significant peaks may be identified through the following procedures, where the first procedure may be local maxima extraction and the second procedure may be statistical thresholding. In the statistical thresholding procedure, only peaks exceeding the mean spectral power plus three times standard deviation (where the mean and the standard deviation are computed from noise-dominated baseline regions) may be retained. For example, the standard deviation may represent the standard deviation of the entire spectrum. The standard deviation may quantify the dispersion of spectral power values in non-peak regions around the mean spectral power level. This statistically rigorous threshold may reliably distinguish true Doppler sources from random background noise.

To address potential over-fragmentation of true Doppler sources, spatially proximate peaks within a resolution-dependent merging radius are consolidated into single peak positions. For a consolidated peak, we then characterize its spectral footprint by determining a 3 dB region. The 3 dB region may be defined as the frequency span where power drops by half relative to the peak maximum. Collectively, these processed 3 dB regions may constitute the final Doppler regions of interest, providing robust spectral localization for subsequent target motion analysis.

As an example, given a sequence representing the MUSIC spectrum, a sequence Sₗₚ may be obtained after applying a low pass filter. Significant peaks may be found based on local maxima of Sₗₚ, selecting those whose amplitude exceeds the mean plus three times the standard deviation. If significant peaks are too close, they will be merged as a single peak position. Subsequently, a 3 dB region for one or more peaks may be determined. The Doppler regions of interest may be identified by the MUSIC-like eigen-decomposition method.

The high-resolution Doppler estimator 102 may be a processing circuit configured for performing high-resolution Doppler estimation utilizing LASSO (L1-regularized) sparse recovery algorithm. LASSO, representing Least Absolute Shrinkage and Selection Operator, is a regression method. The LASSO solvers may minimize a cost function with two components, a data fidelity term and an L1 penalty term. This approach may directly enable L1-regularized sparse recovery in Doppler systems.

The LASSO method hereby may be a linear regression technique that enhances estimation accuracy by introducing an L1 constraint λ|β|₁. The LASSO method may achieve this by adding a penalty term to the standard least squares objective function, which encourages sparsity in the model's coefficients. Sparsity, through L1 regularization, may suppress mirror artifacts and noise. The formula of \hat{®} is,

$$β = arg {min}_{β} \{ \frac{1}{2 n} {\vert y - X β \vert}_{2}^{2} + λ {\vert β \vert}_{1} \}$$

where \hat{β} are high resolution estimates, y are observations, λ|β|₁ is an L1 constraint. By carefully designing according to the regions with significant signal energy, high resolution estimates \hat{β} may be obtained. Then Doppler components may be obtained accordingly.

Within the identified Doppler regions, a sparse recovery problem may be formulated. The LASSO algorithm may be applied to extract high-resolution Doppler components, suppressing mirror artifacts and noise. The L1 regularization may leverage the sparsity of the Doppler spectrum in practical scenarios.

The signal processing system 100 may output a high-resolution Doppler spectrum based on the non-uniformly sampled signals from the TDD system, enabling accurate velocity estimation for ISAC applications.

In some examples, the architecture of the signal processing system 100 may also be adapted for other wireless standards (e.g., 6G, Wi-Fi) and for Multiple-Input Multiple-Output (MIMO) ISAC systems. MIMO-based ISAC frameworks for 5G NR may utilize existing antenna arrays to perform simultaneous communication and sensing. The Third Generation Partnership Project's (3GPP) 5G NR standard, for example, includes the MIMO-based ISAC frameworks for NR. Regarding the signal processing system 100, further optimization may reduce computational complexity for real-time embedded implementations.

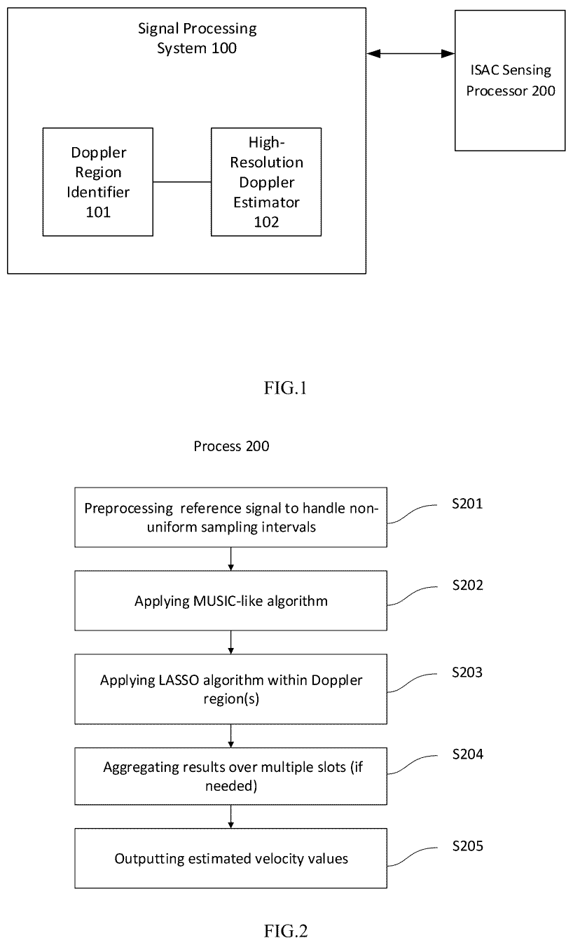

FIG. 2 illustrates an example of a logic flow. As shown in FIG. 2, a process 200 may be an example Doppler estimation process flow in a 5G NR TDD ISAC system. The process 200 may include operations S201, S202, S203, S204 and S205.

In a 5G NR TDD ISAC system, the process 200 may further include receiving a reference signal prior to the operation S201. The reference signal may be received from a TDD system. Due to TDD scheduling, the reference signal may be sampled non-uniformly in time, creating non-uniform sampling intervals.

In the operation S201, the reference signal may be preprocessed to handle non-uniform sampling intervals. In some examples, the reference signal may be preprocessed due to the non-uniform sampling intervals. For example, the reference signal may be normalized for subsequent spectral analysis. In the operation S202, a MUSIC-like algorithm may be applied to the preprocessed reference signal. Doppler region(s) of interest may be identified in the operation S202. In the operation S203, based on the identified Doppler region(s) of interest, the LASSO algorithm (L1 regularization) may be applied for high-resolution estimation. In the operation S204, if needed, results over multiple slots may be aggregated. In the operation S205, estimated velocity values may be outputted. In some examples, a high-resolution Doppler spectrum may be outputted and the velocity values may be derived from the Doppler spectrum.

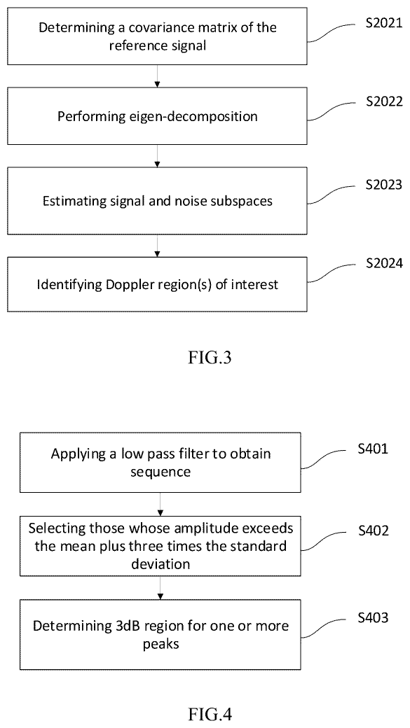

FIG. 3 illustrates another example of a logic flow. In some examples, the operation S202 may include operations S2021, S2022, S2023 and S2024. The operations S2021, S2022, S2023 and S2024 are shown in FIG. 3. In some examples, in the operation S2021, the preprocessed reference signal (being preprocessed in the operation S201) may be used to determine a covariance matrix, for example, to construct a covariance matrix. In the operation S2022, eigen-decomposition may be performed. The results of eigen-decomposition may include separate signal subspace and noise subspace. In the operation S2023, signal subspace and noise subspace may be estimated. In the operation S2024, Doppler region(s) of interest may be identified. Thus, the identified region(s) may be obtained by the operation S202 (applying the MUSIC-like algorithm).

In some examples, in the operation S202 (including the operations S2021, S2022, S2023 and S2024), the MUSIC-like algorithm may scan the Doppler frequency axis to identify regions with significant signal energy. FIG. 4 illustrates yet another example of a logic flow. The logic flow in FIG. 4 includes operations S401, S402 and S403. The operations S401, S402 and S403 may be performed for extracting Doppler regions of interest (high-resolution Doppler components). In some examples, in the operation $401, a MUSIC spectrum may be obtained after a low pass filter is applied. In the operation S402, the MUSIC spectrum whose amplitude exceeds the mean plus three times the standard deviation may be selected. In the operation S403, the 3 dB region for one or more peaks may be determined.

Usually, the MUSIC-like algorithm may generate an initial Doppler spectrum estimate, which inherently contains high-frequency fluctuations due to noise and finite sampling effects. To enhance the reliability of peak detection, a low-pass filter to suppress spectral noise may be applied while preserving dominant Doppler components. Within this smoothed spectrum, significant peaks may be identified through the following procedures, where the first procedure may be local maxima extraction and the second procedure may be statistical thresholding. In the statistical thresholding procedure, only peaks exceeding the mean spectral power plus three times the standard deviation (where mean and standard deviation are computed from noise-dominated baseline regions) may be retained. This statistically rigorous threshold may reliably distinguish true Doppler sources from random background noise. To address potential over-fragmentation of true Doppler sources, spatially proximate peaks within a resolution-dependent merging radius are consolidated into single peak positions. For a consolidated peak, we then characterize its spectral footprint by determining the 3 dB region. The 3 dB region may be defined as the frequency span where power drops by half relative to the peak maximum. Collectively, these processed 3 dB regions may constitute the final Doppler regions of interest, providing robust spectral localization for subsequent target motion analysis.

For example, given a sequence representing the MUSIC spectrum, a sequence Sip may be obtained after applying a low pass filter. Significant peaks may be found based on local maxima of Stp, selecting those whose amplitude exceeds the mean plus three times the standard deviation. If significant peaks are too close, they will be merged as a single peak position. Subsequently, the 3 dB region for one or more peaks may be determined. Doppler regions of interest may be identified.

In some examples, a two-step LASSO method may be proposed. The two-step LASSO method may include the operations as shown in FIG. 2, FIG. 3 and FIG. 4. The two-step LASSO method may be implemented by the signal processing system 100 as shown in FIG. 1. The two-step LASSO method may include step 1 corresponding to the MUSIC-like Algorithm and step 2 corresponding to LASSO (L1 Regularization). The two-step LASSO method may include, prior to step 1, preprocessing the signal to account for the non-uniform sampling intervals, normalizing the data for subsequent spectral analysis. The signal may refer to a reference signal. The reference signal may be sampled non-uniformly in time due to TDD scheduling. The step 1 may include determining a covariance matrix using the preprocessed signal, for example, constructing a covariance matrix. Then performing eigen-decomposition to separate signal subspace and noise subspace. The Doppler frequency axis may be scanned by the MUSIC-like algorithm to identify regions with significant signal energy, even under non-uniform sampling. The step 2 may include applying the LASSO algorithm to extract high-resolution Doppler components. The mirror artifacts and noise may be suppressed. A sparse recovery problem may be formulated within the identified Doppler regions. The step 2 leverages the sparsity of the Doppler spectrum in practical scenarios. The two-step LASSO method may output estimated velocity values. Then a high-resolution Doppler spectrum based on the non-uniformly sampled signals from the TDD system may be obtained, enabling accurate velocity estimation for ISAC applications.

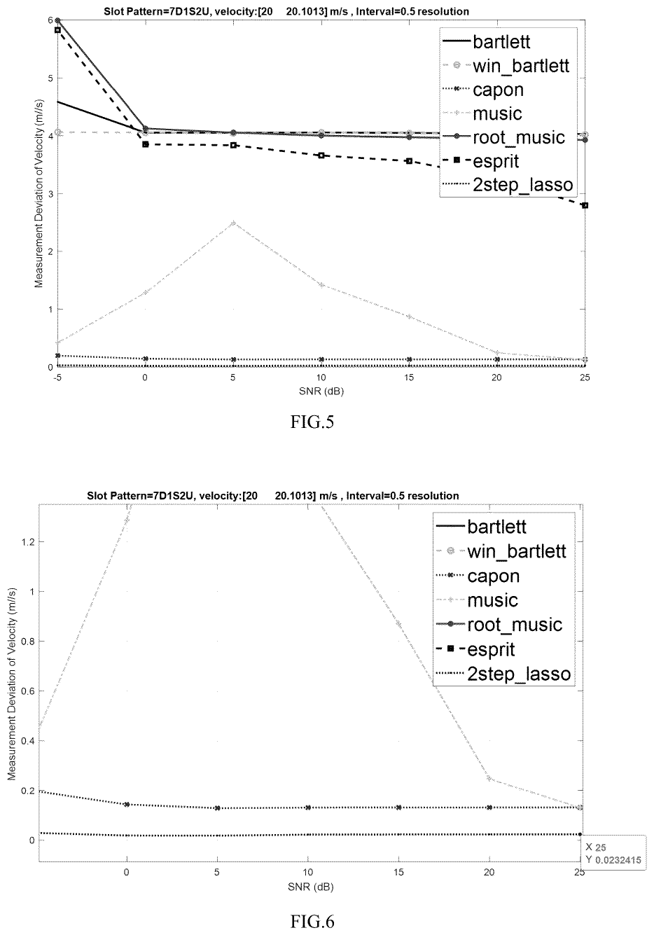

Simulations may be carried out for comparison of the performance of different algorithms including the two-step LASSO method. In an example simulation, a slot pattern 7D1S2U is assumed in a Doppler estimation process in a 5G NR TDD ISAC system. The pattern of slots is DDDDDDDSUU which is a typical frame pattern for 3GPP NR system. 30 kHz subcarrier spacing is assumed, so each slot (D or S or U) occupies 0.5 ms. FIG. 5 is a schematic diagram illustrating Measurement Deviation of Velocity versus Signal-to-Noise Ratio (SNR) for different algorithms. FIG. 6 is a schematic diagram illustrating a magnified view of Measurement Deviation of Velocity versus SNR for different algorithms. The Measurement Deviation of Velocity may represent velocity estimation accuracy.

FIG.5 depicts the velocity estimation accuracy across varying signal quality conditions, wherein the x-axis represents the SNR in decibels (dB), spanning a range from −5 dB to 25 dB. The y-axis shows the Measurement Deviation of Velocity in meters per second (m/s). FIG. 6 is a magnified view of the region near the bottom of the y-axis in FIG. 5, making the distinctions more evident.

As shown in FIG. 5, the SNR in x-axis shows the comparison of these algorithms in different SNR levels, since usually performance varies across different SNR levels. The Velocity [20 20.1013] m/s represents two velocities in the simulation. The two signals (sources) correspond to these two speeds. Velocity [20 20.1013] means 20.1013−20=0.1013=0.5*0.2026. The Interval=0.5 means two sources are separated only by 0.5 times the resolution. The 400 slots represent 200 ms which determines the resolution of conventional velocity estimation algorithms, that is to say, 0.2026 m/s.

In the simulation, the number of snapshots may be 400 (with some slots possibly missing due to TDD scheduling). Snapshots represent discrete sets of independent signal samples acquired over successive time intervals. Each snapshot contains a full sampling window of coherent data required for Doppler velocity estimation. The number of frequency samples per snapshot may be 1638. The achieved velocity detection resolution may be 0.2026 m/s. The achieved velocity detection resolution may be limited by Coherent Processing Interval (CPI). The Coherent Processing Interval (CPI) may be defined as the time duration spanned by all pulses within a single snapshot, fundamentally governing the achievable velocity resolution through the Fourier uncertainty principle.

The algorithms compared in the simulation may include bartlett, win_bartlett, capon, music, root_music, esprit and 2step-lasso. The bartlett algorithm may refer to a classical periodogram-based method that estimates power spectral density by averaging modified periodograms. The win_bartlett algorithm denoting Windowed Bartlett may refer to an algorithm enhancing the bartlett with tapering windows (e.g., Hamming) to reduce spectral leakage at the cost of resolution. The capon algorithm may refer to an adaptive minimum-variance distortionless response estimator that suppresses interference while preserving signal gain. The music algorithm may refer to a subspace algorithm that exploits noise subspace orthogonality to achieve super-resolution spectral estimates. The root-music algorithm may refer to an algebraic variant of music that solves polynomial roots for higher precision and reduced computational cost. The esprit algorithm may refer to a subspace technique utilizing signal subspace rotational invariance for parameter estimation without spectral search. The 2step-lasso may refer to the two-step LASSO method proposed in the examples.

FIG. 5 presents the complete simulation results for different algorithms, highlighting the performance differences. As shown in FIG. 5, the Measurement Deviation of Velocity for multiple algorithms across SNR are compared in FIG. 5. The results may reflect the benefits of the proposed two-step LASSO method. The results of the simulation may validate the two-step LASSO method capable of a robust suppression of mirroring artifacts. The two-step LASSO method achieves a velocity detection resolution smaller than the resolution defined by CPI, with effective suppression of mirroring artifacts. Specifically, the step 2 may formulate a sparse recovery problem, solve for high-resolution Doppler spectrum and suppress mirroring artifacts.

The two-step LASSO method is robust to missing samples and adaptable to various TDD configurations. Despite the CPI-limited resolution of 0.2 m/s, the two-step LASSO method is capable of clearly distinguishing two sources spaced just 0.1 m/s apart, highlighting its superior resolving capability. As shown in FIG. 5, the two-step LASSO method maintains high detection accuracy even with significant non-uniformity in the sampling pattern, outperforming conventional FFT-based methods (for example, the bartlett algorithm, the win_bartlett algorithm). The two-step LASSO method may also outperform conventional interpolation-based methods. The conventional interpolation-based methods may refer to techniques that reconstruct uniform signal samples from non-uniform TDD slot data using interpolation algorithms, enabling standard FFT processing for Doppler estimation in 5G NR systems.

FIG. 6 zooms in on the part of FIG. 5 near the bottom of the Measurement Deviation of Velocity axis, where the values of the capon algorithm and the 2step-LASSO algorithm are close to zero, making the distinctions more evident. As shown in FIG. 6, the Measurement Deviation of Velocity of the two-step LASSO method may be 0.0232415 m/s at a SNR of 25 dB.

One or more aspects of at least one example may be implemented by representative instructions stored on at least one machine-readable medium which represents various logic within the processor. These instructions, when read by a machine, computing device or system causes the machine, computing device or system to fabricate logic to perform the techniques described herein. Such representations, known as “IP cores”, may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor devices, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. The choice of whether an example is implemented using hardware elements, software elements, or a combination thereof may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or rewriteable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language and syntax to instruct a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled” or the phrase “coupled with”, however, may also mean that two or more elements are not in direct contact with each other, but yet still cooperate or interact with each other.

In the following, various aspects of the present disclosure will be illustrated:

Example 1 is an apparatus including: one or more processors; and one or more non-transitory computer-readable media storing instructions that, when executed by the one or more processors, cause the one or more processors to: receive a first signal for spectral analysis, wherein the first signal is a time division duplex (TDD) signal; apply a MUltiple SIgnal Classification-like (MUSIC-like) algorithm to the first signal to obtain one or more Doppler regions of interest; perform a high-resolution Doppler estimation utilizing Least Absolute Shrinkage and Selection Operator (LASSO) algorithm within the one or more Doppler regions of interest; and output a high-resolution Doppler spectrum for the first signal.

Example 2 includes the subject matter of example 1, wherein the one or more processors are further configured to: receive a reference signal from a TDD circuit; preprocess the reference signal for the spectral analysis; and obtain the preprocessed reference signal as the first signal.

Example 3 includes the subject matter of example 2, wherein the one or more processors are further configured to: determine a covariance matrix based on the preprocessed reference signal; perform eigen-decomposition on the preprocessed reference signal; obtain signal subspace and noise subspace; and identify the one or more Doppler regions of interest based on the signal subspace and the noise subspace.

Example 4 includes the subject matter of example 2, wherein preprocessing the reference signal for the spectral analysis includes normalizing the reference signal for the spectral analysis, and wherein the reference signal is sampled non-uniformly in time from the TDD circuit, and wherein the reference signal is collected during designated slots in TDD frames.

Example 5 includes the subject matter of example 2, wherein the one or more processors are further configured to: apply a low-pass filter to the reference signal to obtain a MUSIC spectrum; select one or more peaks in the MUSIC spectrum with an amplitude exceeding a threshold; and determine the one or more Doppler regions of interest based on the selected one or more peaks.

Example 6 includes the subject matter of example 4, wherein the one or more processors are further configured to: aggregate results of the high-resolution Doppler estimation over multiple slots.

Example 7 is a non-transitory computer-readable medium having instructions stored thereon, that when executed by processing circuitry of a computing device, cause the computing device to perform operations, including: receiving a first signal for spectral analysis, wherein the first signal is a time division duplex (TDD) signal; applying a MUltiple SIgnal Classification-like (MUSIC-like) algorithm to the first signal to obtain one or more Doppler regions of interest; performing a high-resolution Doppler estimation utilizing Least Absolute Shrinkage and Selection Operator (LASSO) algorithm within the one or more Doppler regions of interest; and outputting a high-resolution Doppler spectrum for the first signal.

Example 8 includes the subject matter of example 7, further including instructions that when executed by processing circuitry of the computing device, cause the computing device, prior to applying the MUSIC-like algorithm to the first signal, to: receive a reference signal from a TDD circuit; preprocess the reference signal for the spectral analysis; and obtain the preprocessed reference signal as the first signal.

Example 9 includes the subject matter of example 8, further including instructions that when executed by processing circuitry of the computing device, cause the computing device to: determine a covariance matrix based on the preprocessed reference signal; perform eigen-decomposition on the preprocessed reference signal; obtain signal subspace and noise subspace; and identify the one or more Doppler regions of interest based on the signal subspace and the noise subspace.

Example 10 includes the subject matter of example 8, wherein preprocessing the reference signal for the spectral analysis includes normalizing the reference signal for the spectral analysis, and wherein the reference signal is sampled non-uniformly in time from the TDD circuit, and wherein the reference signal is collected during designated slots in TDD frames.

Example 11 includes the subject matter of example 8, further including instructions that when executed by processing circuitry of the computing device, cause the computing device to: apply a low-pass filter to the reference signal to obtain a MUSIC spectrum; select one or more peaks in the MUSIC spectrum with an amplitude exceeding a threshold; and determine the one or more Doppler regions of interest based on the selected one or more peaks.

Example 12 includes the subject matter of example 10, further including instructions that when executed by processing circuitry of the computing device, cause the computing device, after performing the high-resolution Doppler estimation utilizing the LASSO algorithm within the one or more Doppler regions of interest, to: aggregate results of the high-resolution Doppler estimation over multiple slots.

Example 13 is a method, including: receiving a first signal for spectral analysis, wherein the first signal is a time division duplex (TDD) signal; applying a MUltiple SIgnal Classification-like (MUSIC-like) algorithm to the first signal to obtain one or more Doppler regions of interest; performing a high-resolution Doppler estimation utilizing Least Absolute Shrinkage and Selection Operator (LASSO) algorithm within the one or more Doppler regions of interest; and outputting a high-resolution Doppler spectrum for the first signal.

Example 14 includes the subject matter of example 13, prior to applying the MUSIC-like algorithm to the first signal, further including: receiving a reference signal from a TDD circuit; preprocessing the reference signal for the spectral analysis; and obtaining the preprocessed reference signal as the first signal.

Example 15 includes the subject matter of example 13 or 14, wherein applying the MUSIC-like algorithm to the first signal to obtain one or more Doppler regions of interest includes: determining a covariance matrix based on a preprocessed reference signal; performing eigen-decomposition on the preprocessed reference signal; obtaining signal subspace and noise subspace; and identifying the one or more Doppler regions of interest based on the signal subspace and the noise subspace.

Example 16 includes the subject matter of any one of examples 13 to 15, wherein preprocessing the reference signal for the spectral analysis includes normalizing the reference signal for the spectral analysis, and wherein the reference signal is sampled non-uniformly in time from the TDD circuit, and wherein the reference signal is collected during designated slots in TDD frames.

Example 17 includes the subject matter of any one of examples 13 to 16, wherein applying the MUSIC-like algorithm to the first signal to obtain one or more Doppler regions of interest further includes: applying a low-pass filter to the reference signal to obtain a MUSIC spectrum; selecting one or more peaks in the MUSIC spectrum with an amplitude exceeding a threshold; and determining the one or more Doppler regions of interest based on the selected one or more peaks.

Example 18 includes the subject matter of any one of examples 13 to 17, further including: aggregating results of the high-resolution Doppler estimation over multiple slots.

Example 19 is one or more computer-readable media storing instructions which, when executed by one or more processors, cause the one or more processors to perform the subject matter of any one of examples 13 to 18.

Example 20 is a computing apparatus comprising means for performing the subject matter of any one of examples 13 to 18.

Example 21 is a computer program product comprising instructions which, when executed by one or more processors, cause the one or more processors to perform the subject matter of any one of examples 13 to 18.

Example 22 is a computer program comprising instructions which, when executed by one or more processors, cause the one or more processors to perform the subject matter of any one of examples 13 to 18.

While the above descriptions and connected figures may depict electronic device components as separate elements, skilled persons will appreciate the various possibilities to combine or integrate discrete elements into a single element. Such may include combining two or more circuits to form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature and are thus understood as capable of being implemented in a corresponding device. Likewise, it is appreciated that implementations of devices detailed herein are understood as capable of being implemented with a corresponding method. It is thus understood that a device corresponding to a method detailed herein may include one or more components configured to perform each aspect of the related method.

What is claimed is:

1. An apparatus comprising:
one or more processors; and
one or more non-transitory computer-readable media storing instructions that, when executed by the one or more processors, cause the one or more processors to:
receive a first signal for spectral analysis, wherein the first signal comprises a time division duplex (TDD) signal;
apply a MUltiple SIgnal Classification-like (MUSIC-like) algorithm to the first signal to obtain one or more Doppler regions of interest;
perform a high-resolution Doppler estimation utilizing Least Absolute Shrinkage and Selection Operator (LASSO) algorithm within the one or more Doppler regions of interest; and
output a high-resolution Doppler spectrum for the first signal.

2. The apparatus of claim 1, wherein the one or more processors are further configured to:
receive a reference signal from a TDD circuit;
preprocess the reference signal for the spectral analysis; and
obtain the preprocessed reference signal as the first signal.

3. The apparatus of claim 2, wherein the one or more processors are further configured to:
determine a covariance matrix based on the preprocessed reference signal;
perform eigen-decomposition on the preprocessed reference signal;
obtain signal subspace and noise subspace; and
identify the one or more Doppler regions of interest based on the signal subspace and the noise subspace.

4. The apparatus of claim 2, wherein:
the preprocess the reference signal for the spectral analysis comprises normalize the reference signal for the spectral analysis,
the reference signal is sampled non-uniformly in time from the TDD circuit, and
the reference signal is collected during designated slots in TDD frames.

5. The apparatus of claim 2, wherein the one or more processors are further configured to:
apply a low-pass filter to the reference signal to obtain a MUSIC spectrum;
select one or more peaks in the MUSIC spectrum with an amplitude exceeding a threshold; and
determine the one or more Doppler regions of interest based on the selected one or more peaks.

6. The apparatus of claim 4, wherein the one or more processors are further configured to:
aggregate results of the high-resolution Doppler estimation over multiple slots.

7. At least one non-transitory computer-readable medium having instructions stored thereon, that when executed by processing circuitry of a computing device, cause the computing device to perform operations, comprising:
receive a first signal for spectral analysis, wherein the first signal comprises a time division duplex (TDD) signal;
applying a MUltiple SIgnal Classification-like (MUSIC-like) algorithm to the first signal to obtain one or more Doppler regions of interest;
performing a high-resolution Doppler estimation utilizing Least Absolute Shrinkage and Selection Operator (LASSO) algorithm within the one or more Doppler regions of interest; and
outputting a high-resolution Doppler spectrum for the first signal.

8. The non-transitory computer-readable medium of claim 7, further comprising instructions that when executed by processing circuitry of the computing device, cause the computing device, prior to applying the MUSIC-like algorithm to the first signal, to:
receive a reference signal from a TDD circuit;
preprocess the reference signal for the spectral analysis; and
obtain the preprocessed reference signal as the first signal.

9. The non-transitory computer-readable medium of claim 8, further comprising instructions that when executed by processing circuitry of the computing device, cause the computing device to:
determine a covariance matrix based on the preprocessed reference signal;
perform eigen-decomposition on the preprocessed reference signal;
obtain signal subspace and noise subspace; and
identify the one or more Doppler regions of interest based on the signal subspace and the noise subspace.

10. The non-transitory computer-readable medium of claim 8, wherein:
the preprocess the reference signal for the spectral analysis comprises normalizing the reference signal for the spectral analysis,
the reference signal is sampled non-uniformly in time from the TDD circuit, and
the reference signal is collected during designated slots in TDD frames.

11. The non-transitory computer-readable medium of claim 8, further comprising instructions that when executed by processing circuitry of the computing device, cause the computing device to:
apply a low-pass filter to the reference signal to obtain a MUSIC spectrum;
select one or more peaks in the MUSIC spectrum with an amplitude exceeding a threshold; and
determine the one or more Doppler regions of interest based on the selected one or more peaks.

12. The non-transitory computer-readable medium of claim 10, further comprising instructions that when executed by processing circuitry of the computing device, cause the computing device, after performing the high-resolution Doppler estimation utilizing the LASSO algorithm within the one or more Doppler regions of interest, to:
aggregate results of the high-resolution Doppler estimation over multiple slots.

13. A method, comprising:
receiving a first signal for spectral analysis, wherein the first signal comprises a time division duplex (TDD) signal;
applying a MUltiple SIgnal Classification-like (MUSIC-like) algorithm to the first signal to obtain one or more Doppler regions of interest;
performing a high-resolution Doppler estimation utilizing Least Absolute Shrinkage and Selection Operator (LASSO) algorithm within the one or more Doppler regions of interest; and
outputting a high-resolution Doppler spectrum for the first signal.

14. The method of claim 13, prior to applying the MUSIC-like algorithm to the first signal, further comprising:
receiving a reference signal from a TDD circuit;
preprocessing the reference signal for the spectral analysis; and
obtaining the preprocessed reference signal as the first signal.

15. The method of claim 13, wherein applying the MUSIC-like algorithm to the first signal to obtain one or more Doppler regions of interest comprises:
determining a covariance matrix based on a preprocessed reference signal;
performing eigen-decomposition on the preprocessed reference signal;
obtaining signal subspace and noise subspace; and
identifying the one or more Doppler regions of interest based on the signal subspace and the noise subspace.

16. The method of claim 14, wherein:
the preprocessing the reference signal for the spectral analysis comprises normalizing the reference signal for the spectral analysis,
the reference signal is sampled non-uniformly in time from the TDD circuit, and
the reference signal is collected during designated slots in TDD frames.

17. The method of claim 14, wherein applying the MUSIC-like algorithm to the first signal to obtain one or more Doppler regions of interest further comprises:
applying a low-pass filter to the reference signal to obtain a MUSIC spectrum;
selecting one or more peaks in the MUSIC spectrum with an amplitude exceeding a threshold; and
determining the one or more Doppler regions of interest based on the selected one or more peaks.

18. The method of claim 16, further comprising:
aggregating results of the high-resolution Doppler estimation over multiple slots.
